(19) United States
(12) Patent Application Publication
(10) Pub. No.: US 2025/0119898 A1
(43) Pub. Date: Apr. 10, 2025

(54) NETWORK NODE AND METHOD THEREIN

(71) Applicant: Telefonaktiebolaget LM Ericsson (publ), Stockholm (SE)

(72) Inventors: Ananya MUDDUKRISHNA, Enskededalen (SE); Dhruvin PATEL, Aachen (DE); Yufei BLANKENSHIP, Kildeer, IL (US); Fedor CHERNOGOROV, Espoo Uusimaa (FI)

(21) Appl. No.: 18/291,304

(22) PCT Filed: Jul. 27, 2021
(86) PCT No.: PCT/SE2021/050750

§ 371 Date: Jan. 23, 2024

(51) Int. Cl. H04W 72/121; H04W 72/54

(52) U.S. Cl. CPC H04W 72/121; H04W 72/54

(57) ABSTRACT

A method performed by a first network node for reducing radio interference in a wireless communications network is provided. The first network node obtains a first traffic profile of a first User Equipment (UE). The first traffic profile is indicative of a first traffic pattern of the first UE in a communication direction. The first network node obtains a second traffic profile of a second UE. The second traffic profile is indicative of a second traffic pattern of the second UE in a second communication direction. Based on the obtained first and second traffic profiles, the first network node determines one or more transmission parameters for scheduling communication for the first UE in the first communication direction. Based on the one or more transmission parameters, the first network node schedules communication for the first UE in a first cell of the first network node.

### TECHNICAL FIELD

Embodiments herein relate to a network node and a method therein. Furthermore, a computer program and a computer readable storage medium are also provided herein. In particular, embodiments herein relate to scheduling radio communication in a wireless communications network.

### BACKGROUND

In a typical wireless communications network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as areas covered by a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node. In the following, for brevity, ‘network node’ is used to refer to a radio access network node, unless otherwise stated, while ‘core network node’ refers to a logical entity in the core network. 3GPP is the standardization body for specifying the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands used for 5G NR are mainly in two different frequency ranges, Frequency Range 1 (FR1) and Frequency Range 2 (FR2), with more frequency ranges being investigated for higher carrier frequency bands (e.g., 52.6-71 GHz, 71-114.25 GHz). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may bring benefit to system performance when each UE only has one antenna. Such systems and/or related techniques are commonly referred to as MIMO.

Scheduling communication in a wireless communications network is generally performed without knowledge of the traffic pattern of UE. However, some exceptions exist, e.g. Downlink (DL) semi-persistent scheduling, scheduling for Uplink (UL) configured grant and scheduling for dynamic grants, where some information of the traffic pattern of the UE is known and used for scheduling UE communication. This may also be exemplified with the use Time-Sensitive Communication Assistance Information (TSCAI) as discussed in 3GPP TS 23.501 version 17.1.1, which describes Time-Sensitive Communication (TSC) traffic characteristics for use in a 5G System. TSCAI may for example be used by a 5G Access Network (5G-AN) when provided by a Session Management Function (SMF) and allows for scheduling of periodic and deterministic traffic flows either via Configured Grants, Semi-Persistent Scheduling or with Dynamic Grants. Information comprised in TSCAI is further specified in Table 5.27.2-1 in 3GPP TS 23.501 as shown below.

TABLE 5.27.2-1
TS 23.501: TSC Assistance Information (TSCAI)

| Assistance | |
|---|---|
| Information | Description |
| Flow Direction | The direction of the TSC flow (uplink or downlink) |
| Periodicity | It refers to the time period between start of two bursts. |
| Burst Arrival | The latest possible time when the first packet of the |
| time | data burst arrives at either the ingress of the RAN |
| (Optional) | (downlink flow direction) or egress interface of the UE |
| | (uplink flow direction). |
| Survival Time | It refers to the time period an application can survive |
| (Optional) | without any burst, as defined in clause C.2.3 of TS 22.104. |

### SUMMARY

As a part of developing embodiments herein a problem was first identified and will be discussed herein. In existing radio networks, transmission parameters which are used for scheduling communication for a UE are often set passively for each packet to and from the UE. This means that the transmission parameters for a given UE are set without knowledge of traffic patterns of the given UE and other active UEs which may affect the communication of the UE. Without clear knowledge of these traffic patterns, scheduling of communication will be sub-optimal and thus the performance of the wireless communications network may not satisfy the requirements of active UEs in the wireless communications network in an efficient manner. Collision and interference may result if scheduling decisions of each communication are made independently without adjusting for traffic needs and/or potential interference relating to other active UEs.

An object of embodiments herein is to improve the performance of a wireless communications network.

According to an aspect of embodiments herein, the object is achieved by a method performed by a first network node for scheduling radio communication in a wireless communications network. The first network node obtains a first traffic profile of a first UE. The first traffic profile is indicative of a first traffic pattern of the first UE in a first communication direction. The first network node obtains a second traffic profile of a second UE. The second traffic profile is indicative of a second traffic pattern of the second UE in a second communication direction. Based on the obtained first and second traffic profiles, the first network node determines one or more transmission parameters for scheduling communication for the first UE in the first communication direction. Based on the one or more transmission parameters, the first network node schedules communication for the first UE in a first cell of the first network node.

According to another aspect of embodiments herein, the object is achieved by a first network node configured to schedule radio communication in a wireless communications network. The first network node is configured to obtain a first traffic profile of a first UE. The first traffic profile is indicative of a first traffic pattern of the first UE in a first communication direction. The first network node is configured to obtain a second traffic profile of a second UE. The second traffic profile is indicative of a second traffic pattern of the second UE in a second communication direction. The first network node is configured to determine one or more transmission parameters for scheduling communication for the first UE in the first communication direction, based on the obtained first and second traffic profiles. The first network node is configured to schedule communication for the first UE in a first cell of the first network node, based on the one or more transmission parameters.

It is furthermore provided herein a computer program comprising instructions, which, when executed on at least one processor, cause the at least one processor to carry out any of the methods above, as performed by the network node. It is additionally provided herein a computer-readable storage medium, having stored thereon a computer program comprising instructions which, when executed on at least one processor, cause the at least one processor to carry out the method according to any of the methods above, as performed by the network node.

Since the first and second traffic profiles are obtained, the first network node is informed of the first and second traffic patterns of the first and second UEs in the first and second communication directions. Using the information of the first and second traffic patterns, the first network node is enabled to determine which transmission parameters are best suited for scheduling communication in the first communication direction to support the second and first traffic profile while reducing or avoiding interference between the first and second UEs. In this way, based on the determined transmission parameters, the first network node efficiently schedules the communication for the first UE in the first communication direction.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting an embodiment of a method in a first network node.

FIG. 3 is a schematic block diagram illustrating embodiments herein.

FIG. 4 is a schematic block diagram illustrating embodiments herein.

FIG. 5 is a schematic block diagram illustrating embodiments herein.

FIG. 6 is a combined sequence diagram and flowchart illustrating embodiments herein.

FIGS. 7a-b are schematic block diagrams illustrating embodiments of a wireless device.

FIG. 8 schematically illustrates a telecommunications network connected via an intermediate network to a host computer.

FIG. 9 is a generalized block diagram of a host computer communicating via a base station with a user equipment over a partially wireless connection.

FIGS. 10-13 are flowcharts illustrating methods implemented in a communication system including a host computer, a base station and a user equipment.

### DETAILED DESCRIPTION

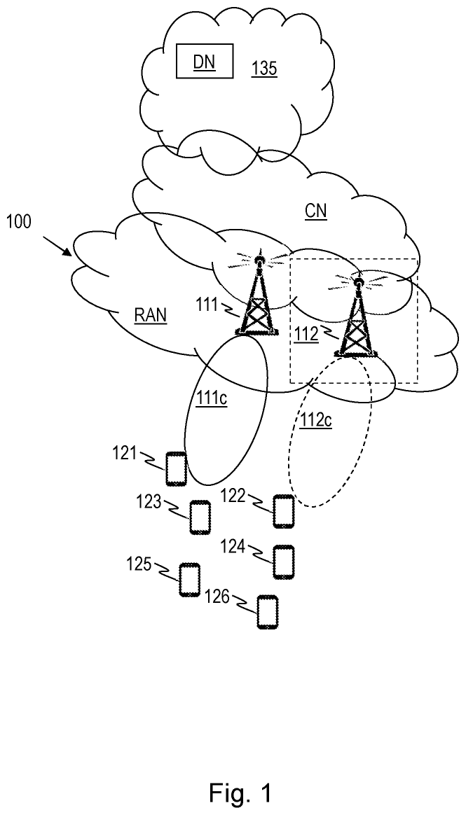

FIG. 1 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMAX), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g. a first network node 111. The wireless communications network 100 may also in some embodiments comprise a second network node 112. The network first node 111 may provide radio coverage in a first cell 111c, and the second network node 112 may provide radio coverage in a second cell 112c, e.g. for one or more UEs 121, 122, 123, 124, 125, 126. In some embodiments, the first network node 111 may serve the one or more UEs 121, 122, 123, 124, 125, 126 in the first cell 111c. In some embodiments, the second network node 112 may serve some of the one or more UEs 121, 122, 123, 124, 125, 126 in the second cell 112c. The first network node 111 and the second network node 112 may respectively each be any of a NG-RAN node, a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area served by the respective network node. The first network node 111 and the second network node 112 may each respectively be referred to as a serving radio network node and schedules communication for one or more UEs 121, 122, 123, 124, 125, 126 in at least one communication direction, e.g. DL transmissions to the UEs 121, 122, 123, 124, 125, 126 and/or UL transmissions from the UEs 121, 122, 123, 124, 125, 126.

In the wireless communications network 100, one or more UEs operate, such as e.g. the first UE 121 and the second UE 122. The first UE 121 is served by the first network node 111 in the first cell 111c. The second UE 122 may be served by the first network node 111 in the first cell 111c, and may in other embodiments be served by the second network node 112 in the second cell 112c. The wireless communications network 100 may also comprise, additionally to the first and second UEs 121, 122, any one or more UEs, e.g. a third UE 123, a fourth UE 124, a fifth UE 125, and/or a sixth UE 126. The one or more UEs 123, 124, 125, 126 may e.g. each respectively be served by either the first network node 111 or the second network node 112.

Each UE, e.g. out of the first UE 121, the second UE 122, the third UE 123, the fourth UE 124, the fifth UE 125, and/or the sixth UE 126 may each respectively also be referred to as an IoT device, a mobile station, a non-access point (non-AP) STA, a STA, and/or a wireless terminals. Each UE, e.g. out of the first UE 121, the second UE 122, the third UE 123, the fourth UE 124, the fifth UE 125, and/or the sixth UE 126 may each respectively communicate via one or more Access Networks (AN), e.g. RAN, to one or more Core Networks (CN). It should be understood by the skilled in the art that “wireless device” or UE, is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

Methods herein may be performed by the first network node 111. As an alternative, a Distributed Node (DN) and functionality, e.g. comprised in a cloud 135 as shown in FIG. 1, may be used for performing or partly performing the methods herein.

Embodiments herein relate to better scheduling UE communication in the wireless communications network 100. This may be achieved by avoiding radio resource collision and reducing radio interference by exploiting information in obtained traffic profiles. A traffic profile as used herein indicates a traffic pattern of a UE, e.g. the first UE 121 and/or the second UE 122, in a specific communication direction, e.g. UL, DL, or Sidelink (SL). A traffic pattern as used herein may comprise information of one or more data packets communicated in the communication direction during some period of time.

The traffic profile may be comprised in a traffic profile message, and may comprise: a message size of payload data, periodicity of data arrival, offset of data arrival time relative to the start of the periodicity, latency requirement, reliability requirement. The traffic profile message may be constructed by a core network node, e.g., a Session Management Function (SMF) node, which core network node send the traffic profile message to the radio access network node. Alternatively, the first UE 121 and/or the second UE 122 may construct its respective traffic profile message based on higher layer information, e.g., application layer traffic characteristics, and send it to a network node handling scheduling of the UE communication.

Knowledge of traffic profiles of the first UE 121 and/or the second UE 122 enables the first network node 111 to more efficiently schedule communication as in embodiments herein. For example, a traffic profile of the first UE 121 and/or the second UE 122 may be sent from the respective UE to the first network node 111 and/or to the second network nose 112. This may be accomplished when a handshaking procedure between the first UE 121 or the second UE 122 and the respective first network node 111 or the second network node 112 used at the start of a communication session. Alternatively, the traffic profile of the first UE 121 and/or the second UE 122 may be sent from a core network node to the first network node 111 and/or second network node 112. With the knowledge of traffic profiles of the first UE 121 and/or the second UE 122 relating to communication in the same or otherwise interfering communication direction, the first network node 111 is enabled to more efficiently determine transmission parameters used for scheduling communication in the communication direction. Without this knowledge, the scheduling decision may instead need to rely on a buffer status at the first network node 111 for DL transmission, and/or a buffer status report of the first UE 121 and/or the second UE 122 for UL transmission. Such information tends to be inaccurate, not up-to-date, and/or without prediction power of the needs of future packets. Embodiments herein may thus increase efficiency of scheduling communication across several aspects which will be explained by embodiments herein. As an example, it is possible to determine transmission parameters used for scheduling UE communication in a first communication direction specific to the UE, e.g. by scheduling the use of specific time slot and/or frequency location and/or spatial angle in said first communication direction, e.g., UL, DL, or SL, best suited for the traffic patterns indicated by the respective traffic profiles. In this way, embodiments herein achieve a more efficient scheduling of communication and reduces interference, and thus improves the performance of the wireless communications network.

The embodiments herein may for example achieve a more efficient scheduling by any one or more out of: (1) minimization of resource collision between two UEs, if both UEs have data packets to be sent; (2) reduction of intra-cell interference between two UEs in the same cell; (3) reduction of inter-cell interference between two UEs in neighboring cells; (3) avoidance of inter-network node interference for a Time Division Duplex (TDD) network; (4) resource sharing between two UEs if they share certain characteristics, or are complementary to each other in certain characteristics; and/or (5) power saving for the network node and the UE.

A number of embodiments will now be described, some of which may be seen as alternatives, while some may be used in combination.

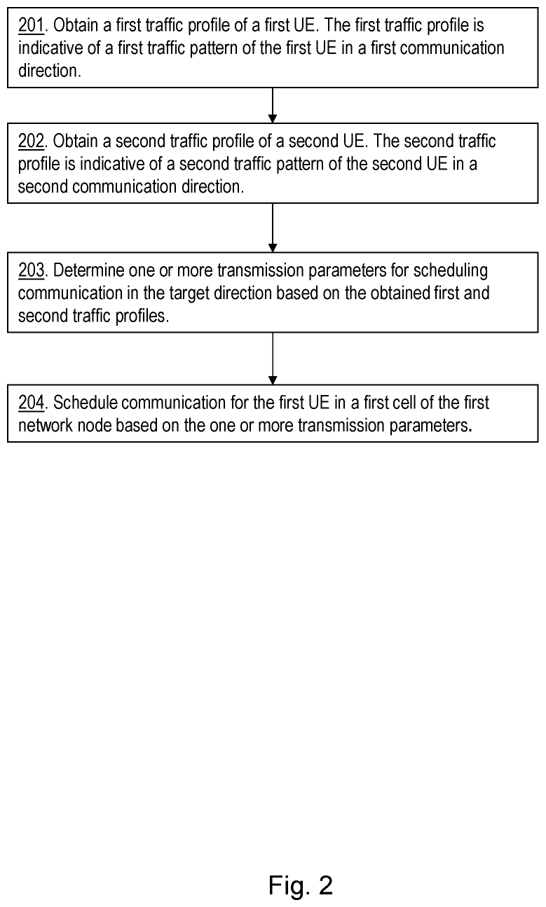

FIG. 2 shows example embodiments of a method performed by the first network node 111 for reducing radio interference in the wireless communications network 100. The following actions may be performed in any suitable order.

Action 201. The first network node 111 obtains the first traffic profile of the first UE 121. The first traffic profile is indicative of the first traffic pattern of the first UE 121 in the first communication direction. In other words, the first network node 111 may be made aware of communication performed by, or to be performed for, the first UE 121 in the first communication direction. Here the first communication direction may be DL, wherein the first UE 121 receives data packets from the first network node 111. Alternatively, the first communication direction may be UL wherein the first UE 121 transmits data packets in the UL towards the network node. The first communication direction may also be SL, wherein the first UE 121 transmits data packets to another UE and/or receives data packets from said another UE, e.g. the second UE 122.

Some data packets may be indicated by the first traffic pattern to be periodic, e.g., communicated once per X second, once per Y transmission time units (TTI), etc. Some data packets may also be aperiodic, e.g., communicated every time a certain event occurs. Some data packets may be of the same size each time, in which case the data packet size may be directly included in the first traffic profile. In general, the data packet size may vary from time to time, and the data packet size characteristics may be indicated in terms of one or more of the following: maximum data packet size, minimum data packet size, the average data packet size, the maximum data rate to be supported for the first traffic pattern, and/or the minimum data rate to be supported for the first traffic pattern.

In some embodiments, the first network node 111 obtains the first traffic profile by obtaining one or more traffic profiles, wherein each traffic profile out of the one or more traffic profiles is indicative of a respective traffic pattern of a respective UE out of one or more UEs. In these embodiments, the first traffic profile may e.g. be one of the one or more traffic profiles. The one or more traffic profiles may each be a traffic profile indicating a respective traffic patterns of any one of the first, third, fourth, fifth, and/or sixth UE, 121, 123, 124, 125, 126.

Action 202. The first network node 111 obtains the second traffic profile of the second UE 122. The second traffic profile is indicative of the second traffic pattern of the second UE in the second communication direction. In this way, the first network node 111 has information of the traffic patterns in the first and second communication directions of the first and second UEs 121, 122. In some embodiments, the first and second traffic pattern indicates that the first and second traffic interferes with each other. In some embodiments, the first and second traffic patterns indicate that scheduling communication in the first and/or second communication directions may cause interference to the first and/or second traffic patterns. The first and second communication directions may be in the same communication direction, e.g. both in DL, or may be in separate communication directions which communication directions may interfere.

In some embodiments, the first network node 111 obtains the second traffic profile by receiving a coordination message from the second network node 112. In these embodiments, the coordination message is indicative of the second traffic profile. In these embodiments, the second UE 122 is served in the second cell 112c of the second network node 112. In this way, the first network node 111 is informed of the second traffic pattern of the second UE 122 served in the second cell 112c.

Action 203. Based on the obtained first and second traffic profiles, the first network node 111 determines one or more transmission parameters for scheduling communication in the first communication direction. In other words, the first network node 111 may determine how the communication of the first traffic pattern and the second traffic pattern in the first and second communication directions relate to each other. This may mean to determine if and/or how the communication indicated by the obtained traffic patterns would cause interference and/or resource collision to each other, and thus to minimize these negative effects, e.g., by avoiding to schedule data packets of the first UE 121 and the second UE 122 simultaneously. Alternatively, the scheduler may determine that the first UE 121 and the second UE 122 may be served simultaneously such that radio resources and power resources may be used more efficiently. For example, for FR2, only one analog beam may be used in one TTI across the frequency domain. When the first UE 121 and the second UE 122 are both within coverage of the same analog beam, then these two UEs 121, 122 may be scheduled simultaneously, thus achieving more efficient radio resource utilization. Another example is to leverage MU-MIMO techniques to serve multiple UEs simultaneously. As another example, the first network node 111 may determine transmission parameters for a beam sweeping configuration, such that a beam sweeping pattern of the first network node 111 matches the indicated by first and/or second traffic pattern. In yet another example, by observing the traffic profiles of the UEs, e.g. the first and the second traffic profiles, the first network node 111 may group the data packet transmission of UEs into periods of high-activity time followed by periods of low-activity time and/or no activity time, without compromising the requirement of their respective traffic. The first network node 111 may thus go into a power saving mode, when not in the high-activity time to save power. This may cause the first network node 111 to, e.g., turn off some radio communication, skip transmission of certain DL signals, and/or skip reception of certain UL signals.

In some embodiments, the first network node 111 determines the one or more transmission parameters based on the coordination message. In these embodiments, the second UE is served in the second cell 112c by the second network node 112. In this way, the first network node 111 determines the transmission parameters based on inter-cell information of traffic indicated in the second traffic profile indicated by the coordination message. This may be related to traffic that would in other cases cause interference for the first UE 121, when scheduling communication for the first UE 121. When the first network node 111 is aware of traffic profile of neighbor cell's UE, coordination between two neighbor network nodes can be achieved. For example, the first network node 111, may take into account the traffic profile of the second UE 122 in the second cell 112c to avoid interference from traffic of the second UE 122. For TDD, interference mitigation may be achieved in terms of interference from the transmission of the second network node 112. In another example, using knowledge of traffic profiles of the first and second UEs 121, 1222 in two neighbor cells 111c, 112c, the first network node 111 and the second network node 112 may coordinate and go into low-activity power saving mode at different time periods, thus achieving network power saving without being radio silent in both cells at the same time.

In some embodiments, the first network node 111 determines the one or more transmission parameters based on the obtained one or more traffic profiles.

Action 204. Based on the one or more transmission parameters, the first network node 111 schedules communication for the first UE 121 in the first cell 111c of the first network node 111. Thereby, achieving an improved scheduling due to determining the one or more transmission parameters based on the obtained first and second traffic profiles.

In some embodiments, the first network node 111 schedules communication for the first UE 121 by scheduling communication for the one or more respective UEs in the first cell 111c of the first network node 111. In these embodiments, the first UE 121 may be one of the one or more UEs.

In some embodiments herein, e.g. relating to the actions 201-204 above, the first communication direction and the second communication direction may respectively comprise any one or more out of:
DL transmission of data,
UL transmission of data,
SL transmission of data from the first UE 121 to the second UE 122, and
SL transmission of data from the second UE 122 to the first UE 121.

In other words, the embodiments herein may be performed with regards to any combination of communication directions, e.g. both UL transmission, or a combination of DL transmission and SL transmission.

In some embodiments herein, e.g. relating to the actions 201-204 above, the first traffic profile is obtained by receiving the first traffic profile from the first UE 121 or by receiving the first traffic profile from a first network function, and wherein the second traffic profile is obtained by receiving the second traffic profile from the second UE 122, or by receiving the second traffic profile from a second network function. In some of these embodiments the first network function is part of a core network node which transmits the first traffic profile to the first network node 111, or wherein the first network function is part of the first network node 111. In some of these embodiments, the second network function is part of a core network node which transmits the second traffic profile to the second network node 112, or wherein the second network function is part of the second network node 112. The first and second network functions may be the same network function or may be separate network functions, depending on if the first UE 121 and the second UE 122 are served by the same network function. The first and/or second network functions may be a respective SMF. The first and/or second network functions may respectively be a core network logical entity associated with the first and/or the second network node 111, 112.

In some embodiments herein, e.g. relating to the actions 201-204 above, the first and/or second traffic pattern respectively indicate any one or more out of:
aperiodic and/or periodic traffic,
a priority level for communicated data packets,
message size characteristics, wherein the size characteristics may e.g. indicate a fixed size for data packets in the respective communication direction or may e.g. indicate a maximum, minimum and/or average size of data packets in the respective communication direction, and
a latency, a data rate, and/or a reliability requirement for communicated data packets.

Periodic traffic, e.g. as described above, may comprise recurring messages and/or data packets which need to be transmitted or received according to a predefined periodicity P₀, e.g., P₀=10 ms to indicate that data packets recur once every 10 ms. An arrival time T₀, may also be defined, e.g. predefined, such that data packets appear at time instance T₀, T₀+P₀, T₀+2*P₀, T₀+3*P₀. The reason for a periodical transmission may be a periodic update of a position or a repeated monitoring of a characteristic parameter. The periodic transmission may be started once and may be continuous until a stop command is provided.

For aperiodic traffic, the data packets do not recur at regular, predictable time instances. Instead, an aperiodic transmission is, for example, a transmission which is triggered instantaneously by an event. Example events are: (a) process events, where the events come from the process when a monitored metric, e.g., temperature, pressure, and/or velocity, has exceeded a threshold or have fallen below a threshold; (b) diagnostic events, where the events indicate malfunctions of an automation device or module; (c) maintenance events, where the events that indicate necessary maintenance work to prevent the failure of an automation device.

Traffic patterns such as the first and/or the second traffic pattern may comprise either or both of aperiodic traffic and period traffic.

Priority levels, e.g. as described above, e.g., including a default priority level, may be included as a 5G quality of service (QOS) parameter. There may be a range of priority level values. Example services in the order of high to low priority levels are provided as follows. Mission critical delay sensitive signalling has a priority level 5, i.e. a high priority. Vehicle to everything (V2X) messages for collision avoidance has a priority level 18, i.e., a high priority. Mission critical data has a priority level 55, i.e. a low priority. Buffered streaming video has a priority level 90, i.e. a low priority. When a higher priority service overlaps with a lower priority service, the first network node 111 may determine the one or more transmission parameters such that to satisfy the higher priority service first, while the remaining resources can be used towards lower priority service.

In some embodiments herein, e.g. relating to the actions 201-204 above, the one or more transmission parameters comprises any one or more out of:
information of arrangement of time and/or frequency resources for communication in the first communication direction,
information of antenna configuration to be used for communication in the first communication direction, and
a grouping parameter indicating a group of UEs, wherein the group of UEs communicate concurrently in the first communication direction, and wherein the group of UEs comprises the first UE 121.

The information of arrangement of time and/or frequency resources above may e.g. cause the first network node 111 to schedule the communication for the first UE 121 using a different frequency than communication scheduled for the second UE 122 during the same time.

The antenna configuration described above may be used for e.g. defining a number of MIMO layers, assisting beamforming in the first communication direction, and/or a defining a beam sweeping pattern. The information of antenna configuration may cause the first network node 111 to schedule communication for the first UE 121 according to its traffic needs. For example, if the message size is large, e.g., 1000 bytes or more, a larger number of MIMO layers, e.g., 4 layer, is used, whereas single layer MIMO may be used if the message size is small, e.g., 32 bytes or lower. When data packets of a traffic pattern, e.g. the first traffic pattern, has a periodicity of 10 ms, then the first network node 111 may ensure that a beam points to the first communication direction of UE 121 every 10 ms.

The grouping parameter as described above may e.g. be used when there is simultaneous communication for one or more UEs in the first communication direction. The grouping parameter may thus cause the first network node 111 to schedule communication for the first UE 121 simultaneously with other UEs in the group. For example, when MU-MIMO is feasible for serving the first UE 121 and the second UE 122 simultaneously in the first communication direction, e.g. when the first and second communication direction is the same communication direction, and the first and second traffic patterns both indicates data packets in the first communication direction at the same T. The first UE 121 and the second UE 122 may then be scheduled at the same time T in a suitable MU-MIMO manner.

In some embodiments herein, e.g. relating to the actions 201-204 above, the traffic patterns of embodiments herein, e.g. the first and/or second traffic pattern, each respectively indicates deterministic radio communication from a respective UE. In these cases, the UEs, e.g. the first and/or second UE 121, 122 may be IoT devices, communicating using a deterministic traffic pattern, wherein a deterministic traffic pattern may mean a traffic pattern describing that a delay between a transmission of a data packet and a receipt of the message at the destination is stable, e.g. within a defined bound.

The above embodiments will now be further explained and exemplified below. The embodiments below may be combined with any suitable embodiment above.

Transmission configuration within a cell. With the knowledge of the first and second traffic profiles, the first network node 111 may determine transmission parameters as in action 203 above, e.g. depending on what is most suitable with respect to the first and second traffic patterns indicated by the first and second traffic profiles. In one example scenario, the traffic patterns of each UE, e.g. the first traffic pattern of the first UE 121 and the second traffic pattern of the second UE 122, may be used to determine transmission parameters deciding a precoding matrix for communication, wherein the precoding matrix determines a shaping of MIMO beams.

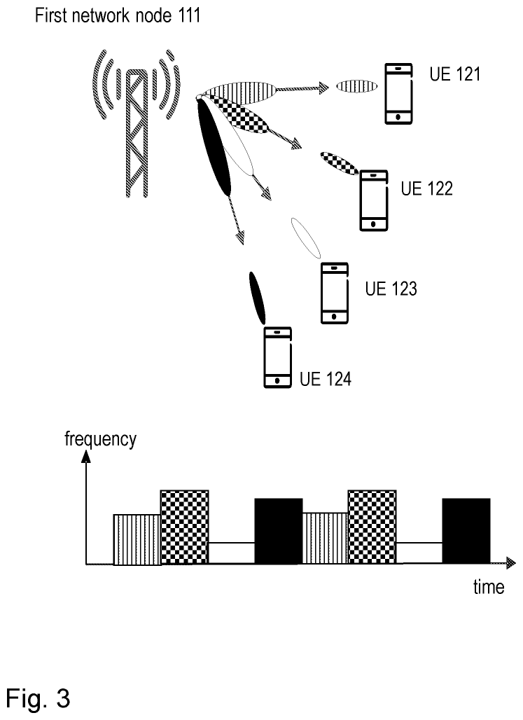

The first and second traffic patterns may be used as a basis for determining the arrangement of time and frequency resources of communication for the first UE 121. The first network node 111 may e.g. determine transmission parameters which relates to a beam sweeping pattern that matches with one or more traffic patterns of the UEs, e.g. the first and the second traffic pattern of the first and second UE 121, 122. This is illustrated in FIG. 3. In FIG. 3, the first UE 121 communicates with the first network node 111 using a beam illustrated with stripes, the second UE 122 communicates with the first network node 111 using a beam illustrated with a checkered pattern, the third UE 123 communicates with the first network node 111 using a beam illustrated with a white fill, and the fourth UE 124 communicates with the first network node 111 using a beam illustrated with a black fill. All of the beams are for communication in the same communication direction. In FIG. 3. the first network node 111 determines one or more transmission parameters based on the traffic profiles of at least the first and second UE 121, 122, e.g. the first and second traffic profile indicative of the first and second traffic patterns. The first network node 111 may also determine the one or more transmission parameters further based on the traffic profile of the third UE 123 indicative of a third traffic pattern of the third UE 123 in the communication direction. Similarly, the first network node 111 may also determine the one or more transmission parameters further based on the traffic profile of the fourth UE 124 indicative of a fourth traffic pattern of the fourth UE 124 in the communication direction. The transmission parameters may be determined to use the first and second traffic patterns, and e.g. the third and fourth traffic patterns, to schedule the UEs 121, 122, 123, 124 by arranging their respective communication in time, frequency and spatial domain. Each of the UEs 121, 122, 123, 134 in FIG. 3 is then scheduled to communicate using a different time using beam sweeping, and e.g. may then overlap in frequency without interfering with each other.

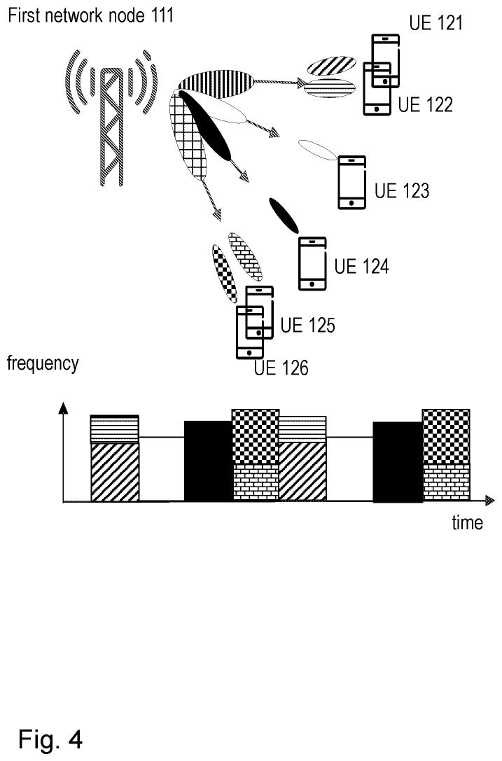

In another example scenario as illustrated by FIG. 4, the traffic patterns, e.g. the first and/or the second traffic pattern, may be used to group two or more UEs, e.g. the first and second UE 121, 122, for transmissions with the respective UEs to be communicated concurrently, i.e. at the same time. The first UE 121 may be grouped with any other one or more UE such as e.g. the second UE 122, the third UE 123, the fourth UE 124, the fifth UE 125, and/or the sixth UE 126. In the illustrated scenario of FIG. 4, the first UE 121 is grouped with the second UE 122, and the fifth UE 125 is grouped with the sixth UE 126.

The grouping of UEs may be performed with the use of UE spatial information of each of the UEs to be grouped, e.g. wherein the spatial information of each UE is obtained, and then UEs which may share a certain spatial property is grouped. In one example, the UEs that are covered by a same analog beam may be grouped together and served at the same time, e.g. the first UE 121 and the second UE 122. The grouped UEs may then be scheduled on the same or different frequency locations. In another example, UEs, e.g. the first UE 121 and the second UE 122, which may be paired on orthogonal, or close to orthogonal, spatial communication directions may be scheduled simultaneously on the same time and frequency resources, i.e., using any suitable MU-MIMO methodology. The grouping may be used together with the first and/or second traffic profile for efficient scheduling, e.g., two or more UEs in the same group such as the first UE 121 and the second UE 122, may both have data packets scheduled for transmission at the same time instance T. The data packets may be stored in a buffer before scheduled for transmission which introduces delay to the data packets. The maximum amount of time a data packet can be delayed may depend on one or more parameter part of the traffic profile, e.g. the first traffic profile. For example, these parameters may indicate whether the traffic is deterministic or non-deterministic, a delay budget for data packets from a UE, e.g. the first UE 121, a survival time for data packets from a UE, e.g. the first UE 121. These parameters may independently, or in some combination, indicate the maximum time a data packet may be delayed. The first network node 111 may then schedule data packets accordingly, e.g. such that as many data packets as possible is not delayed more than allowed.

With analog beamforming, all frequency domain resources use the same beam. Thus, it is important to know how UEs may be grouped to be served together. This is illustrated in FIG. 4, where the first UE 121 and the second UE 122 are identified e.g. as indicated by the first and second traffic pattern, to be in the same communication direction of a spatial beam, and also to have the same traffic timing. The first and second UE 121, 122 may thus be served at the same time, but at frequency domain location, e.g. using Single-User MIMO (SU-MIMO). Similar grouping is done for the fifth and sixth UEs 125, 126. When a channel quality is good, e.g. indicated by the first and/or second traffic pattern, a grouping of UEs for Multi-User MIMO (MU-MIMO) may also be performed, where two UEs, e.g. the first and second UEs 121, 122 are served during the same time and frequency domain, but on different spatial layers.

Transmission coordination between cells. At the network level, coordination among all network nodes, e.g. the first network node 111 and the second network node 112 may be performed, e.g. determining the transmission parameters based on consideration of all traffic of the UEs in both network nodes 111, 112. One aspect is to use the knowledge of any of the UEs traffic profiles, e.g. the first and second traffic profiles, to assist with interference management between the first and second network nodes 111, 112. In embodiments relating to intercell communication of traffic patterns, the second UE is served in the second cell 112c by the second network node 112.

When obtaining the traffic pattern of at least the second UE 122 in the second cell 112c, it may be possible to determine how the second cell 112c interferes with communication in the first cell 111c. The traffic pattern of the second cell 112 may thus be obtained, e.g. by means of the first network node 111 receiving from the second network node 112, a coordination message indicating a traffic profile of at least the second UE 122, when the second UE 122 is served by the second network node 112 in the second cell 112c.

In some embodiments, the traffic pattern of the UEs, e.g. the first and/or second traffic patterns, is deterministic, and thus, the interference the second cell 112c poses on the first cell 111c may be determined by the first network node 111.

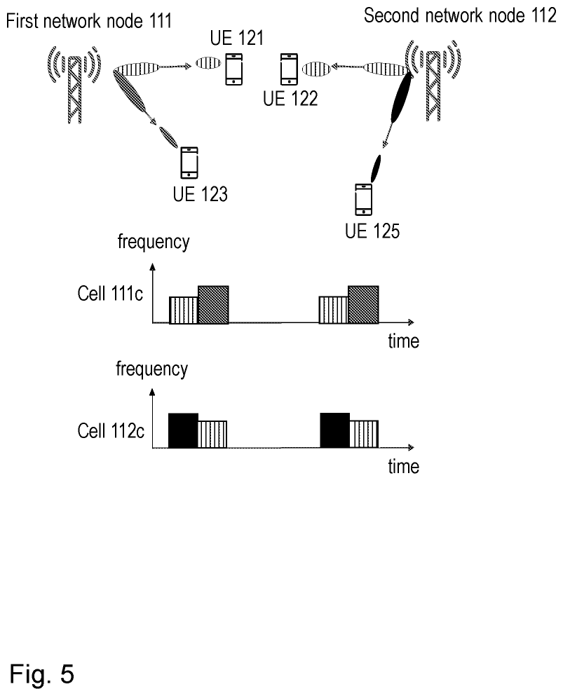

Two or more neighbor network nodes, e.g. the first and second network nodes 111, 112 may then schedule traffic in their cells 111c, 112c, respectively. Since e.g. the first network node 111 knows the traffic pattern indicating traffic in the second cell 112c, the first network node 111 may determine transmission parameters and schedule communication for the first UE 121, and/or for one or more UEs 123, 124, in the communication direction in the first cell 111c in an orthogonal way, e.g. with respect to time, frequency, and/or space, to avoid interference with communication to be scheduled by the second network node 112 in the second cell 112c. This is illustrated in FIG. 5. Without inter-cell coordination, when the first network node 111 transmit to the first UE 121 in the first cell 111c, and the second network node transmits to the second UE 122 in the second cell 112c at the same time, then severe inter-cell interference will cause transmission failure to both the first UE 121 and the second UE 122. On the other hand, if the first and second network nodes 111, 112 coordinate on the UEs traffic pattern and spatial property, e.g. by the second network node 112 sending a coordination message to the first network node 111 and/or vice versa, the respective network nodes 111, 112 may determine transmission parameters and schedule communication to the first and second UEs 121, 122 to be at different time intervals, and in this way, inter-cell interference is avoided.

To achieve this inter-cell coordination, a management function may be introduced configured to coordinate the first and second network node 111, 112, e.g. configured to send the coordination message, and/or trigger the sending of the coordination message. The management function may be, e.g. comprised in or associated with any of the first and/or second network nodes 111, 112.

Communication attributes. Communication may in some embodiments herein be characterised by two attributes: periodicity and determinism. In other words, the traffic patterns, e.g. the first and or second traffic patterns may describe communication of their respective UEs in terms of their communication determinism and periodicity.

Periodic transmissions. In embodiments herein, periodicity means that a transmission interval is repeated. In other words, a certain type of communication is recurring. For example, a transmission from the first UE occurs, e.g. in DL or in UL, every 15th millisecond. Periodic transmissions may relate to e.g. a periodic update of a position, a repeated monitoring of a characteristic parameter, and/or any message that is necessary to communicate in a periodic manner. Some periodic transmission e.g. when embodiments herein relate to automation, may have short transmission intervals, e.g. tens of milliseconds such as e.g. 10, 20, or 30 ms. A periodic transmission may be started once and may be continuous, e.g. with respect to a transmission interval, unless a stop command is provided.

Aperiodic transmissions. In some embodiments herein, the traffic patterns, e.g. the first and/or second traffic patterns relates to aperiodic transmissions. An aperiodic transmission may relate to non-periodic transmissions and may be deterministic. E.g. an aperiodic transmission may be triggered, e.g. instantaneously, by an event. Events may be defined by a control system or by a user. In some embodiments, events triggering certain aperiodic transmissions in certain communication directions are preconfigured for the first network node 111 and may relate to a wide range of scenarios of why e.g. a first UE 121, need to communicate. Example events triggering aperiodic transmissions may be any one or more out of:
process events which come from a process, e.g. executing at the first network node 111, the first UE 121, or the second UE 122, when at least one threshold is fulfilled, e.g. exceeded or fallen below, e.g., relating to sensor data such as e.g. temperature and/or pressure level,
diagnostic events which indicate a malfunction of a device, e.g. the first or second UE 121, 122, an automation device, and/or a module relating to the first network node 111, the malfunction may relate to e.g., power supply failure; short circuit, and/or too high temperature,
maintenance events relating to information that indicates necessary maintenance work to prevent the failure of a device, e.g. the first or second UE 121, 122, an automation device, and/or a module relating to the first network node 111.

Events triggering aperiodic transmissions may further relate to any type of alarm in the wireless communications network 100. In this context, alarms may be messages that inform a controller or operator that an event has occurred, e.g., relating to an equipment malfunction, a process deviation, or other abnormal condition requiring a response. The receipt of the alarm may be acknowledged usually within a short time period by the application that received the alarm, e.g. executing on the first UE 121. When no acknowledgment is received from the application after a predetermined time, the alarm is sent again after another predetermined time or some failure response action may be started.

Determinism. Determinism and deterministic transmissions with regards to communication in a communication direction, e.g. as specified by the traffic patterns, e.g. the first and/or the second traffic patterns, may mean that a delay between a transmission of a message and a receipt of the message at the destination is stable, e.g. within a defined bound. In some embodiments, communication is referred to as deterministic if it is bounded by a given threshold for a latency and/or transmission time. This may be part of the first/and or second traffic profiles. In case of a periodic transmission, the variation of the time interval of the periodic transmission may be bounded for the periodic transmission to be referred to as deterministic.

Scheduling multiple UEs. Similarly, the embodiments herein may be performed in a similar manner for the second UE 122 by its serving network node, e.g. the first network node 111 or the second network node 112. Scheduling of the second UE 122 may be performed concurrently to scheduling the first UE 121. In general, the first network node 111 attempts to serve all UEs connected to it as efficient as possible based on the obtained traffic profiles, e.g. by scheduling any one or more UE herein using the above actions. The efficiency includes radio resource efficiency, energy efficiency of the network nodes and the UEs, implementation efficiency for the network nodes 111, 112 and the UEs 121, 122, 123, 124, 125, 126.

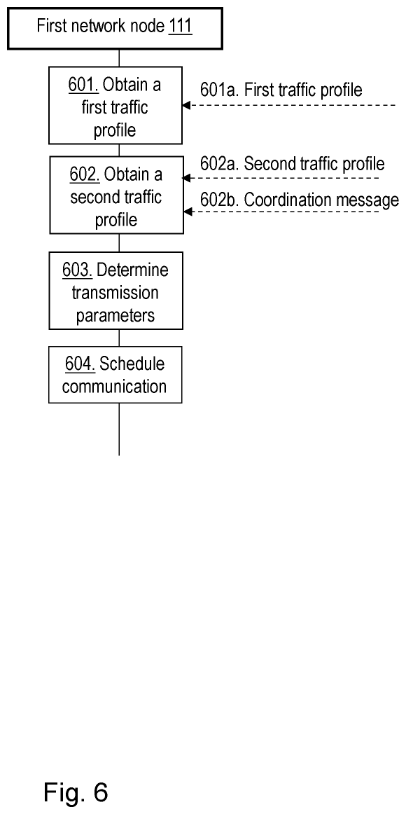

Communication overview. An example scenario is illustrated in FIG. 6 which briefly summarizes the communication performed in relation to the first network node 111. Below actions are example of communication and/or action that may take place in embodiments herein. The following actions are thus only performed when suitable, in any suitable order.

Action 601. The first network node 111 obtains the first traffic profile indicative of the first traffic pattern of the first UE 121. The first network node 111 may also obtain traffic profiles indicative of traffic patterns of one or more other UEs such as the third, fourth, fifth or sixth UE 123, 124, 125, 126. This action may e.g. relate to action 201 above. The first traffic profile may be obtained by receiving 601a the first traffic profile from the first UE 121, or by receiving 601a the first traffic profile from the first network function.

Action 602. The first network node 111 obtains the second traffic profile indicative of the second traffic pattern of the second UE 122. This action may e.g. relate to action 202.

The second traffic profile may be obtained by receiving 602a the second traffic profile from the second UE 121 or by receiving 602a the second traffic profile from the second network function.

When the second UE 122 is served in the second cell 112c, the second traffic profile may be obtained by receiving 602b a coordination message from the second network node 112. The coordination message is indicative of the second traffic profile.

Action 603. The first network node 111 determines one or more transmission parameters for scheduling communication of the first UE 121, e.g. as in action 203 above.

Action 604. The first network node 111 schedules communication for the first UE 121 based on the determined one or more transmission parameters, e.g. as in action 204 above.

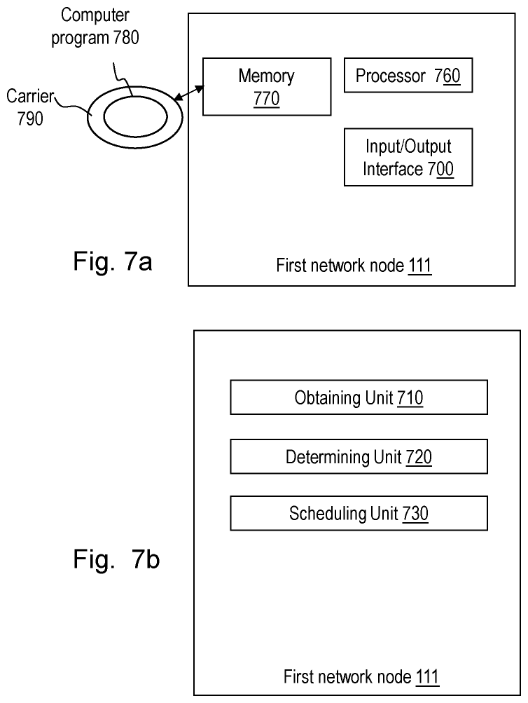

First network node implementation. To perform the method actions above, the first network node 111 is configured to schedule radio communication in a wireless communications network 100. The first network node 111 may comprise an arrangement depicted in FIGS. 7a and 7b.

The first network node 111 may comprise an input and output interface 800 configured to communicate with various network entities such as e.g. any one or more out of the first, second, third, fourth, fifth, or sixth UEs 121, 122, 123, 124, 125, 126, a first network function and/or a second network function, and the second network node 112. The input and output interface 800 may comprise a wireless receiver (not shown) and a wireless transmitter (not shown).

The first network node 111 may further be configured to, e.g. by means of an obtaining unit 710, obtain the first traffic profile of the first UE 121, wherein the first traffic profile is indicative of the first traffic pattern of the first UE 121 in the first communication direction.

The first network node 111 may further be configured to, e.g. by means of the obtaining unit 710, obtain the second traffic profile of the second UE 122, wherein the second traffic profile is indicative of the second traffic pattern of the second UE 122 in the second communication direction.

The first network node 111 may further be configured to, e.g. by means of the obtaining unit 710, obtain the first traffic profile from the first UE 121 by receiving the first traffic profile from the first network function.

The first network node 111 may further be configured to, e.g. by means of the obtaining unit 710, obtain the second traffic profile by receiving the second traffic profile from the second UE 122, or by receiving the second traffic profile from the second network function.

The first network node 111 may further be configured to, e.g. by means of the obtaining unit 710, obtain the second traffic profile by receiving the coordination message from a second network node 112, wherein the coordination message is indicative of the second traffic profile, wherein the second UE 122 is served in the second cell 112c of the second network node 112.

The first network node 111 may further be configured to, e.g. by means of the obtaining unit 710, obtain the first traffic profile by obtaining one or more traffic profiles, wherein each traffic profile out of the one or more traffic profiles is indicative of the respective traffic pattern of the respective UE out of one or more UEs.

The first network node 111 may further be configured to, e.g. by means of a determining unit 720, based on the obtained first and second traffic profiles, determine the one or more transmission parameters for scheduling communication for the first UE 121 in the first communication direction.

The first network node 111 may further be configured to, e.g. by means of the determining unit 720, determine the one or more transmission parameters based on the coordination message.

The first network node 111 may further be configured to, e.g. by means of the determining unit 720, determine the one or more transmission parameters based on the obtained one or more traffic profiles.

The first network node 111 may further be configured to, e.g. by means of a scheduling unit 730, based on the one or more transmission parameters, schedule communication for the first UE 121 in the first cell 111c of the first network node 111.

In some embodiments, the first communication direction and the second communication direction respectively comprise any one or more out of:
DL transmission of data,
UL transmission of data,
SL transmission of data from the first UE 121 to the second UE 122, and
SL transmission of data from the second UE 122 to the first UE 121.

In some embodiments, the first and/or second traffic pattern respectively indicate any one or more out of:
aperiodic and/or periodic traffic,
a priority level for communicated data packets,
message size characteristics, and
a latency, a data rate, and/or a reliability requirement for the communicated data packets.

In some embodiments, the one or more transmission parameters comprises any one or more out of:
information of arrangement of time and/or frequency resources for communication in the first communication direction,
information of antenna configuration to be used for communication in the first communication direction,
a grouping parameter indicating a group of UEs, wherein the group of UEs communicate concurrently in the first communication direction, and wherein the group of UEs comprises the first UE 121.

The embodiments herein may be implemented through a respective processor or one or more processors, such as the processor 760 of a processing circuitry in the first network node 111 depicted in FIG. 7a, together with respective computer program code for performing the functions and actions of the embodiments herein. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The first network node 111 may further comprise a memory 770 comprising one or more memory units. The memory 770 comprises instructions executable by the processor in first network node 111. The memory 770 is arranged to be used to store e.g. information, indications, data, configurations, traffic patterns, traffic profiles, coordination messages, and applications to perform the methods herein when being executed in the first network node 111.

In some embodiments, a computer program 780 comprises instructions, which when executed by the respective at least one processor 760, cause the at least one processor of the first network node 111 to perform the actions above.

In some embodiments, a respective carrier 790 comprises the respective computer program 780, wherein the carrier 790 is one of an electronic signal, an optical signal, an electromagnetic signal, a magnetic signal, an electric signal, a radio signal, a microwave signal, or a computer-readable storage medium.

Those skilled in the art will appreciate that the units in the first network node 111 described above may refer to a combination of analog and digital circuits, and/or one or more processors configured with software and/or firmware, e.g. stored in the first network node 111, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

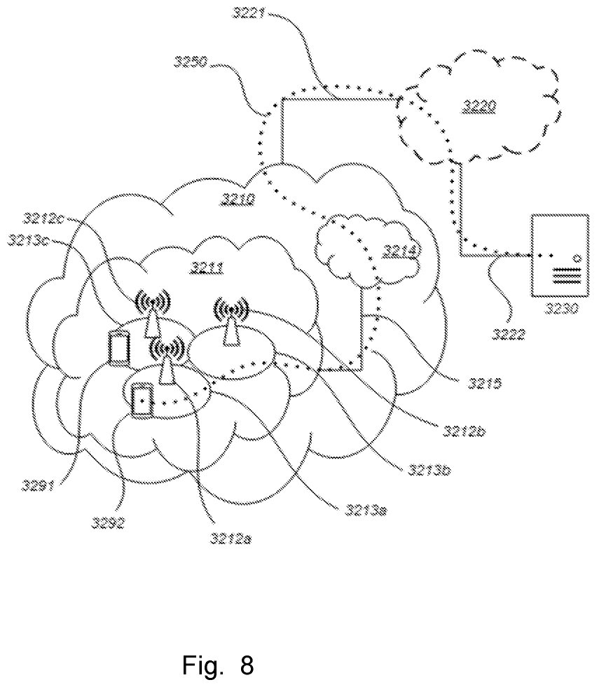

With reference to FIG. 8, in accordance with an embodiment, a communication system includes a telecommunications network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the first network node 111, and/or the second network node 112, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the first UE 121 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunications network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunications network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of UL and DL communications. For example, a base station 3212 may not or need not be informed about the past routing of an incoming DL communication with data originating from a host computer 3230 to be forwarded (e.g., handed over) to a connected UE 3291. Similarly, the base station 3212 need not be aware of the future routing of an outgoing UL communication originating from the UE 3291 towards the host computer 3230.

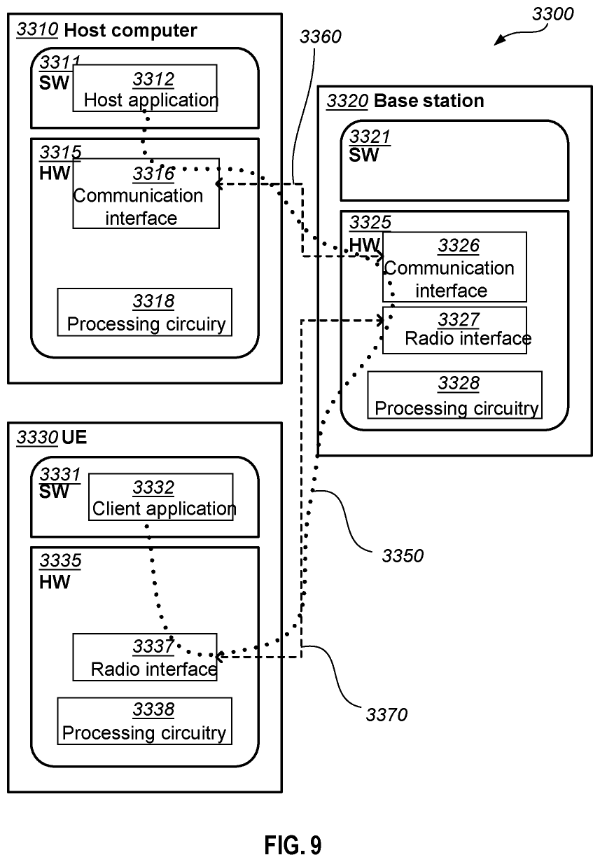

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 8, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, reduced interference, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

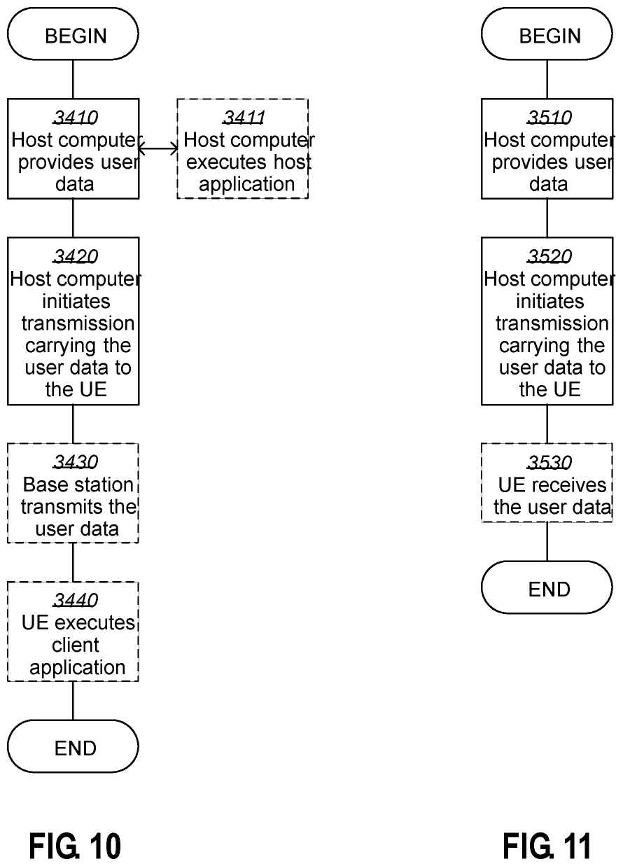

FIG. 10 is a flowchart illustrating a method implemented in a communication system, in accordance with one embodiment. The communication system includes a host computer, a base station such as the network node 112, and a UE such as the first UE 121, which may be those described with reference to FIG. 9 and FIG. 8. For simplicity of the present disclosure, only drawing references to FIG. 10 will be included in this section. In a first action 3410 of the method, the host computer provides user data. In an optional sub action 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 8. For simplicity of the present disclosure, only drawing references to FIG. 11 will be included in this section. In a first action 3510 of the method, the host computer provides user data. In an optional sub action (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

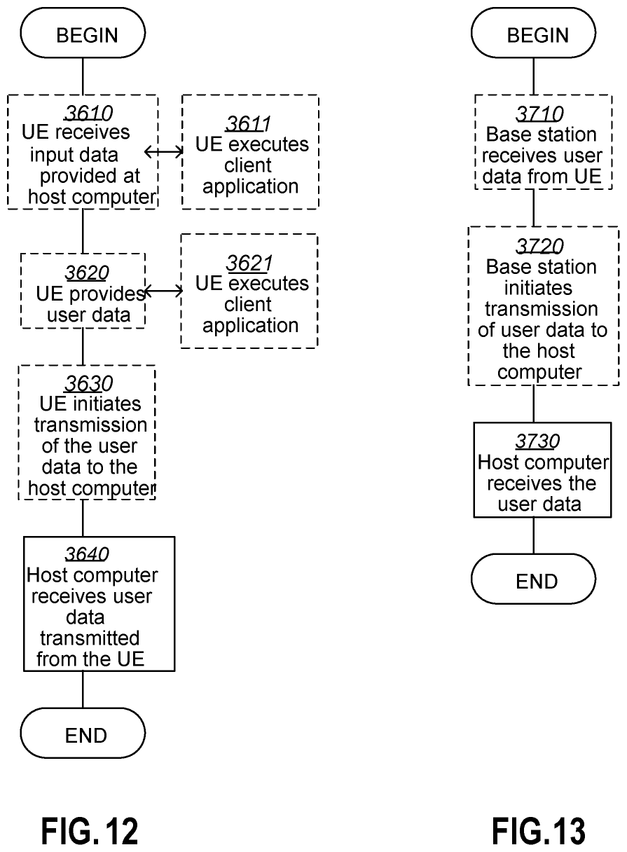

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 8. For simplicity of the present disclosure, only drawing references to FIG. 12 will be included in this section. In an optional first action 3610 of the method, the UE receives input data provided by the host computer. Additionally or alternatively, in an optional second action 3620, the UE provides user data. In an optional sub action 3621 of the second action 3620, the UE provides the user data by executing a client application. In a further optional sub action 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub action 3630, transmission of the user data to the host computer. In a fourth action 3640 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 8. For simplicity of the present disclosure, only drawing references to FIG. 13 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a first network node for scheduling radio communication in a wireless communications network, the method comprising:
obtaining a first traffic profile of a first User Equipment, UE, the first traffic profile being indicative of a first traffic pattern of the first UE in a first communication direction;
obtaining a second traffic profile of a second UE, the second traffic profile being indicative of a second traffic pattern of the second UE in a second communication direction;
based on the obtained first and second traffic profiles, determining one or more transmission parameters for scheduling communication for the first UE in the first communication direction; and
based on the one or more transmission parameters, scheduling communication for the first UE in a first cell of the first network node.

2. The method according to claim 1, wherein the first communication direction and the second communication direction respectively comprises any one or more of:
Downlink, DL, transmission of data;
Uplink, UL, transmission of data;
Sidelink, SL, transmission of data from the first UE to the second UE; and
SL transmission of data from the second UE to the first UE.

3. The method according to claim 1, wherein the first traffic profile is obtained by receiving the first traffic profile from the first UE or by receiving the first traffic profile from a first network function, and wherein the second traffic profile is obtained by receiving the second traffic profile from the second UE, or by receiving the second traffic profile from a second network function.

4. The method according to claim 1, wherein obtaining the second traffic profile comprises receiving from a second network node, a coordination message, wherein the coordination message is indicative of the second traffic profile, wherein the second UE is served in a second cell of the second network node, and wherein determining the one or more transmission parameters is further based on the coordination message.

5. The method according to claim 1, wherein one or both of the first and the second traffic pattern respectively indicate any one or more of:
one or both aperiodic and periodic traffic;
a priority level for communicated data packets;
message size characteristics; and
one or more of a latency, a data rate, and a reliability requirement for communicated data packets.

6. The method according to claim 1, wherein the one or more transmission parameters comprises any one or more of:
information of arrangement of one or both time and frequency resources for communication in the first communication direction;
information of antenna configuration to be used for communication in the first communication direction; and
a grouping parameter indicating a group of UEs, wherein the group of UEs communicate concurrently in the first communication direction, and wherein the group of UEs comprises the first UE.

7. The method according to claim 1, wherein obtaining the first traffic profile comprises obtaining one or more traffic profiles, wherein each traffic profile of the one or more traffic profiles is indicative of a respective traffic pattern of a respective UE of one or more UEs, and wherein determining the one or more transmission parameters is based on the obtained one or more traffic profiles.

8. A first network node configured to handle scheduling of radio communication in a wireless communications network, the first network node is configured to:
obtain a first traffic profile of a first User Equipment, UE, the first traffic profile being indicative of a first traffic pattern of the first UE in a first communication direction;
obtain a second traffic profile of a second UE, being the second traffic profile is indicative of a second traffic pattern of the second UE in a second communication direction;
based on the obtained first and second traffic profiles, determine one or more transmission parameters for scheduling communication for the first UE in the first communication direction; and
based on the one or more transmission parameters, schedule communication for the first UE in a first cell of the first network node.

9. The first network node according to claim 8, wherein the first communication direction and the second communication direction respectively comprises any one or more of:
Downlink, DL, transmission of data;
Uplink, UL, transmission of data;
Sidelink, SL, transmission of data from the first UE to the second UE; and
SL transmission of data from the second UE to the first UE.

10. The first network node according to claim 8, wherein the first network node is configured to obtain the first traffic profile by receiving the first traffic profile from the first UE or by receiving the first traffic profile from a first network function, and wherein the first network node is configured to obtain the second traffic profile by receiving the second traffic profile from the second UE, or by receiving the second traffic profile from a second network function.

11. The method according to claim 8, wherein the first network node is configured to obtain the second traffic profile by receiving a coordination message from a second network node, wherein the coordination message is indicative of the second traffic profile, wherein the second UE is served in a second cell of the second network node, and wherein the first network node is configured to determine the one or more transmission parameters based on the coordination message.

12. The first network node according to claim 8, wherein one or both of the first and the second traffic pattern respectively indicate any one or more of:
one or both aperiodic and periodic traffic;
a priority level for communicated data packets;
message size characteristics; and
one or more of a latency, a data rate, and a reliability requirement for communicated data packets.

13. The first network node according to claim 8, wherein the one or more transmission parameters comprises any one or more of:
information of one or both of arrangement of time and frequency resources for communication in the first communication direction;
information of antenna configuration to be used for communication in the first communication direction; and
a grouping parameter indicating a group of UEs, wherein the group of UEs communicate concurrently in the first communication direction, and wherein the group of UEs comprises the first UE.

14. The first network node according to claim 8, wherein the first network node is configured to:
obtain the first traffic profile by obtaining one or more traffic profiles, wherein each traffic profile of the one or more traffic profiles is indicative of a respective traffic pattern of a respective UE of one or more UEs; and
determine the one or more transmission parameters for the first UE based on the obtained one or more traffic profiles.

15. (canceled)

16. (canceled)

17. The method according to claim 2, wherein the first traffic profile is obtained by receiving the first traffic profile from the first UE or by receiving the first traffic profile from a first network function, and wherein the second traffic profile is obtained by receiving the second traffic profile from the second UE, or by receiving the second traffic profile from a second network function.

18. The method according to claim 2, wherein obtaining the second traffic profile comprises receiving from a second network node, a coordination message, wherein the coordination message is indicative of the second traffic profile, wherein the second UE is served in a second cell of the second network node, and wherein determining the one or more transmission parameters is further based on the coordination message.

19. The method according to claim 2, wherein one or both of the first and the second traffic pattern respectively indicate any one or more of:
one or both aperiodic and periodic traffic;
a priority level for communicated data packets;
message size characteristics; and
one or more of a latency, a data rate, and a reliability requirement for communicated data packets.

20. The method according to claim 2, wherein the one or more transmission parameters comprises any one or more of:
information of arrangement of one or both time and frequency resources for communication in the first communication direction;
information of antenna configuration to be used for communication in the first communication direction; and
a grouping parameter indicating a group of UEs, wherein the group of UEs communicate concurrently in the first communication direction, and wherein the group of UEs comprises the first UE.

21. The method according to claim 2, wherein obtaining the first traffic profile comprises obtaining one or more traffic profiles, wherein each traffic profile of the one or more traffic profiles is indicative of a respective traffic pattern of a respective UE of one or more UEs, and wherein determining the one or more transmission parameters is based on the obtained one or more traffic profiles.

22. The first network node according to claim 9, wherein the first network node is configured to obtain the first traffic profile by receiving the first traffic profile from the first UE or by receiving the first traffic profile from a first network function, and wherein the first network node is configured to obtain the second traffic profile by receiving the second traffic profile from the second UE, or by receiving the second traffic profile from a second network function.
